(19) United States
(12) Patent Application Publication
(10) Pub. No.: US 2016/0147271 A1
(43) Pub. Date: May 26, 2016

(54) POWERING NODES

(71) Applicant: HEWLETT-PACKARD DEVELOPMENT COMPANY, L.P., Houston,, TX (US)

(72) Inventors: Andrew BROWN, Houston, TX (US); David L GRANT, Houston, TX (US)

(21) Appl. No.: 14/900,146

(22) PCT Filed: Jun. 25, 2013
(86) PCT No.: PCT/US2013/047541

§ 371 Date: Dec. 18, 2015

(51) Int. Cl. G06F 1/26

(52) U.S. Cl. CPC G06F 1/26

(57) ABSTRACT

Techniques for powering nodes are provided. In one aspect, a management processor may receive an indication to power up a first node. The management processor may determine a first set of nodes that are to be powered up prior to powering up the first node. A subset of the first set of nodes that are not already powered up may be determined. The subset of nodes may be powered up prior to powering up the first node. The first node may then be powered up.

### BACKGROUND

Modern computers typically include a power control system which receives signals indicating if the computer is to be powered on or powered off. For example, the power button on a computer may not be directly connected to the computer's power supply. Instead, pressing the power button generates a signal, often called a power management event (PME), which is received by power control circuitry within the computer that is always active as long as the computer is connected to power. This circuitry, in turn, activates the power supply of the computer, if the computer was off, thus turning the computer on. Likewise, if the computer was already on, the PME event would cause the computer to shutdown.

In addition, certain components of the computer may be configured to always remain available to some extent, regardless of the power state of the overall computer. For example, a network interface card (NIC) may be configured to remain on regardless of the power state of the computer. When the NIC receives a certain packet, often referred to as a magic packet, the NIC may generate a power on signal, similar to the one described above. Thus, a computer that is in an off state may be woken up through a local area network (LAN) connection. Remote power on of a computer over a network is often referred to as Wake on LAN (WOL).

### BRIEF DESCRIPTION OF THE DRAWINGS

FIG. 1 is an example high level diagram of a system utilizing the node powering techniques described herein.

FIG. 2 is an example of a high level flow diagram for determining a power on sequence of nodes, according to techniques described herein.

FIG. 3 is another example of a high level flow diagram for determining a power on sequence of nodes, according to techniques described herein.

FIG. 4 is an example of a high level flow diagram for ordered powering on of nodes, according to techniques described herein.

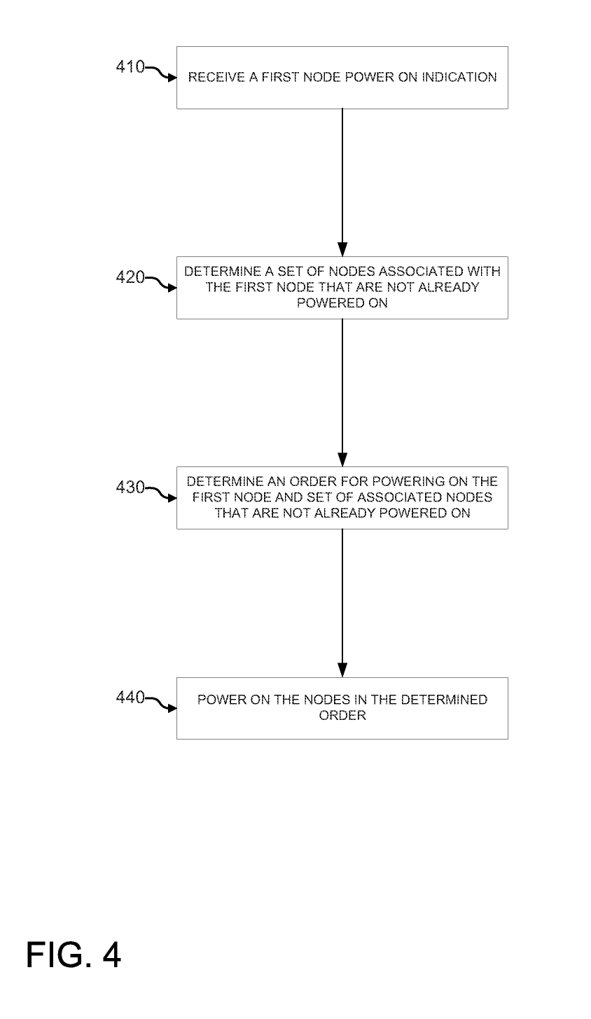

FIG. 5 is another example of a high level flow diagram for ordered powering on of nodes, according to techniques described herein.

### DETAILED DESCRIPTION

The use of a PME signal to power on/off a computer is an effective way to manage a standalone system, because the entire system is either to be turned on or turned off. For example, in a desktop computer, all of the components of the computer, such as the processor, storage (e.g. hard drives), memory, and input/output (IO) devices, will be turned on or off together. Either all of the components should be turned on or none of them should be turned on. Thus, a single PME signal is able to control the entire computer.

However, a problem arises in computer systems that follow a more modular design. In modular computer systems, the various components may be included as standalone entities, which may also be referred to as nodes. For example, one node type may be a compute node, which contains computing resources such as a processor and memory. Another node type may be a storage node, which contains storage resources, such as hard drives. Yet another node type may be an IO node, which contains resources for input/output operations.

The various nodes may be connected via an connection fabric, allowing the nodes to communicate with each other. For example, a compute node may communicate with a storage node that provides storage resources for that compute node. In addition, in some cases the nodes may be shared. For example, two different compute nodes may share a storage node, and both compute nodes use the same storage node to provide persistent storage. Such configurations give rise to a situation in which a particular node does not, and should not, have direct control of the power state of another node. For example, if two compute nodes share a storage node, powering down one compute node should not power down the storage node, otherwise, the second compute node would be left without storage resources.

As should be clear, a single PME signal would be difficult to use in a modular system. For example, if a compute node is sent a power on signal, that signal cannot be directly routed to the associated storage node, because that storage node may already be powered on, providing service to a different compute node. Furthermore, a compute node may need the storage node to be up and running prior to powering on the compute node. For example, the storage node may include the boot resources used by the compute node for booting. Thus, a hardwired PME signal would be ineffective, because the current state of the system would first need to be analyzed to determine which components are to be powered up.

Further exacerbating the problem is the fact that modular systems may be highly configurable through software. For example, a compute node may be associated with a first storage node. By using software to control the connection fabric, the compute node may be disassociated from the first storage node and associated with a second storage node. Proper routing of PME signals to all possible nodes in all possible configurations, while taking into account the current power state of each node, becomes extremely complicated. Furthermore, maintaining dependencies between nodes, such as which nodes are to be powered up prior to powering up other nodes, also becomes complicated.

The techniques described herein overcome these problem by routing a PME event to a management processor. The management processor, sometime referred to as a baseboard management controller, includes information related to the current interconnection status of the various nodes of the modular computer system. As changes are made to the configuration, the management processor is made aware of those changes. Thus, the management processor is aware of the current interconnection status of all of the nodes. Furthermore, when a node is added to the system, meta-data associated with the node informs the management processor of any dependencies that exist. For example, a storage node's meta-data may inform the management processor that the storage node must be operational prior to powering on an associated compute node. The management processor is also aware of the current on/off state of each node.

The management processor is then able to determine which nodes are to be powered up upon receipt of a PME signal for a given node, by analyzing the connection status and the current power state of each node. Furthermore, using the self reported sequencing information provided by each node, the management processor may be able to determine the proper sequence for powering on associated nodes. In addition, the management processor may also know the current state of each node, such that if a node is powered on, it is not necessary to send a power on signal to that node. Finally, the management processor is also able to properly sequence powering down a node. The management processor is aware of all active nodes using the node to be powered down. Thus, the management processor may not power down a node that is in use by another node that is to remain active. These techniques are described in further detail below and in conjunction with the appended figures.

FIG, 1 is an example high level diagram of a system utilizing the node powering techniques described herein. Computing system 100 may include a power source 110, a management processor 120, a connection fabric 130, and a plurality of nodes 140-(1 . . . 9). Power source 110 may be used to provide power to all components of the computing system. Although depicted as a single power source, this is for purposes of simplicity of description. In some implementations, the power source may include several power supply modules. What should be understood is that the computing system includes some source of power and that any particular configuration of that power source is suitable for use with the techniques described herein.

The computing system 100 may also include a management processor 120. The management processor may include a processor 121 that is able to execute instructions. Coupled to the processor may be a non-transitory processor readable medium 122 containing instructions thereon, which when executed by the processor cause the processor to implement the functionality described herein. For example, the medium 122 may include power on/off instructions 123. Power on/off instructions may be used by the management processor to power up/down the various components of system 100, as will be described in further detail below. The medium 122 may also include a node connection data store 124. The node connection data store may be used to store data about the current interconnection of nodes of the computer system 100.

The computer system 100 may also include a connection fabric 130. The connection fabric may allow for communication between the various nodes of the computer system. The connection fabric may be configurable, such that any combination of nodes may be configured to communicate with each other. It should be understood that the connection fabric is not a hardwired connection between nodes, but rather is a software defined connection. Thus, reconfiguring the connection fabric to provide connectivity between different nodes does not require any changes to the hardware of the computer system 100.

The computer system 100 may also include a plurality of nodes 140-1 . . . 9. Although each node may provide different functionality and have a slightly different structure, each node may have a general structure as shown in node 140. Each node may include node resources 141. Node resources are the elements needed for a node to provide the services for which it is designed. Three example types of nodes may include compute nodes, storage nodes, and IO nodes. A compute node may include a processor and memory as resources and thus allows the node to perform computational tasks. A storage node may have persistent storage resources (e.g. hard drives, solid state drives, etc.) and allows the node to provide persistent storage. An IO node may include IO resources (e.g. host bus adaptors, interface cards, etc.) in order to provide IO capabilities to the node.

Each node may also include power control circuitry 142. In general, the power control circuitry receives a signal to turn the node on or off. Any suitable techniques may be used to provide this functionality. For example, the power control circuitry may either connect or disconnect the node from the power supply 110. In other implementations, the power supply itself may be disposed on each node, and the signal may turn the power supply on or off. What should be understood is that regardless of implementation, the power control circuitry allows the node to be turned on or off based on a signal.

Some examples of signals that may be used to control the power control circuitry are the power switch and the WOL signal. Another example of a signal to control the power control circuitry may be a signal generated from an internal clock. For example, a node may be configured using an internal clock to power on at a certain time each day, or on a certain day each week. When the configured time arrives, the internal clock may generate a PME signal. As described above, these signals may be used to direct the node to power on, which may also be referred to as powering up, or power off, which may also be referred to as powering down. As will be described in further detail below, the techniques described herein route the PME signals to the management processor. The management controller then determines to which nodes and in what order the power signals are sent to the nodes.

In addition, each node may have associated meta-data that informs the management processor of any power sequencing information. For example, a storage node's meta-data may inform the management processor that the node is a storage node, and should be powered up prior to any associated compute node. A compute node's meta-data may inform the management processor that any associated storage and IO nodes should be powered up prior to powering up the compute node. If a node should not be powered up until an associated compute node has been powered up, the node meta-data may inform the management processor. When a new node is added to the system, the associated meta-data of the node may be made available to the management processor.

In operation, when a node is added to the computing system, the node's meta data may be provided to the management processor. Thus, the management processor is informed of any power on sequence information for the node. For example, the node should be powered on before or after an associated compute node, the node should be powered on after an associated storage node, etc. In other words, the node meta-data itself is used to inform the management processor of the needed power sequencing information, such that the management processor does not need to be separately configured with that information.

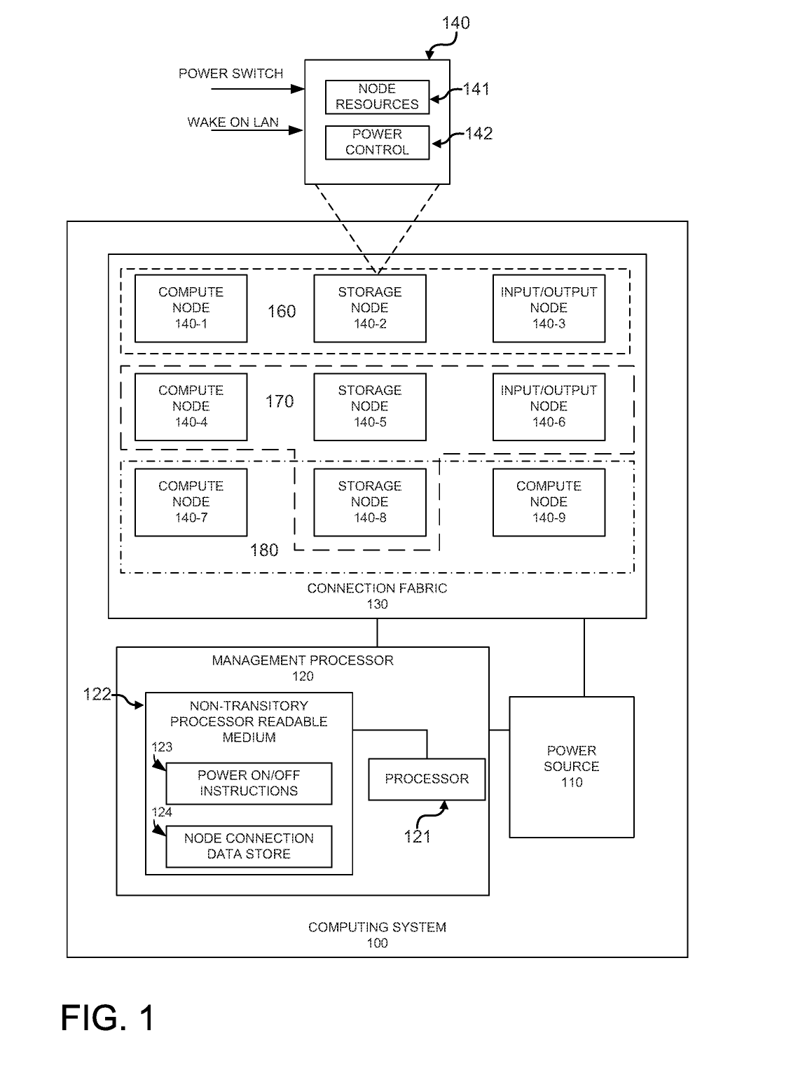

The connection fabric may also be configured to indicate which nodes are connected to each other. As shown in the example system of FIG. 1, three different sets of connections are depicted. Connection 160 shows that compute node 140-1, storage node 140-2, and 10 node 140-3 are all connected. Connection 170 shows that compute node 140-4, storage nodes 140-5,8, and 10 node 140-6 are connected. Connection 180 shows that compute nodes 140-7,9 and storage node 140-8 are connected. It should be noted that storage node 140-8 is used in both connection 170 and 180.

If a PME signal, such as a power button press or WOL signal is received for a node, that signal is routed to the management processor. For example, if a WOL signal is received for compute node 140-1, that signal is routed to the management processor. Utilizing data stored in the node connection data store, the management processor may determine all other nodes that are associated with compute node 140-1. In this example, storage node 140-2 and 10 node 140-3 are associated with compute node 140-1. The management processor may then determine the sequence in which nodes are to be powered on based on the information that was reported by the node. For example, if node 140-2 reported that it should be powered on before an associated compute node, and node 140-3 reported that it should be powered on after an associated compute node, the management processor would know the proper sequencing. In this case, the storage node 140-2 would be powered on first, followed by the compute node 140-1, which would then be followed by the 10 node 140-3.

Once the proper power on sequence is determined, the management processor may first determine if a node is already powered up, in which case it is not necessary to power up the node. Such a situation is described in further detail below, The management processor may then send power on indications to each node that should be powered on, in the determined sequence.

In some cases, it may not be necessary for the management processor to power on a node. For example, assume the nodes in connection 170 are all powered up and operational. Specifically, assume that storage node 140-8 has been powered on. A power on event, such as a WOL signal may be received by compute node 140-7. The management processor may receive this signal and determine, based on the node connection data store, that nodes 140-8 and 140-9 should also be powered up. However, because node 140-8 is already powered up, it is not necessary to send that node a signal to power up. Thus, the management processor simply sends a power on signal to nodes 140-7 and 140-9 in an order that was determined based on the nodes self reporting of power sequencing information.

Although the description presented above was in terms of powering on a node, it should be understood that the same connection and sequencing information can be used to power off or reboot a node. For example, if the power button on node 140-7 were pressed, a signal may be received by the management processor. The management processor may determine all of the nodes that are associated with node 140-7. In this example, that may be nodes 140-8 and 140-9. The ordering of powering down the nodes could either be the reverse of the power up sequence, or could be some other sequence as reported by the node itself. Furthermore, the management processor is also aware of any other nodes that are using a given node. For example, as shown node 140-8 is also being used by connection 170. If node 140-8 were to be powered down, the resources of that node would be lost by connection 170. Thus, the management processor would not power down any nodes if those nodes are also in use by another set of nodes.

The examples presented above were in terms of a set of nodes that are associated at a node level. However, the techniques described herein are not so limited. The techniques may also be used at an application level. For example, assume that connection 160 provides a user interface and computational power for an application program, such as a web server. The web server may be reliant on a backend database service provided by connection 170. Thus, the web server application cannot be operational if the database backend is not operational. The management processor may be made aware of this application level dependency.

Assume that initially all nodes in connections 160 and 170 are off If a power on even is received by a node for the web server connection, the management processor would be aware of all of the nodes within that connection that are to be powered on and the order in which they are to be powered on. However, the management processor is also aware that the web server application is also dependent on the back end database provided by the nodes in connection 170. The management processor is aware that backend database is to be operational prior to powering up the web server. Thus, the management processor may first power up the nodes in connection 170, in the order determined above. Once that has been complete, the nodes in connection 160, forming the web server, may then be powered up.

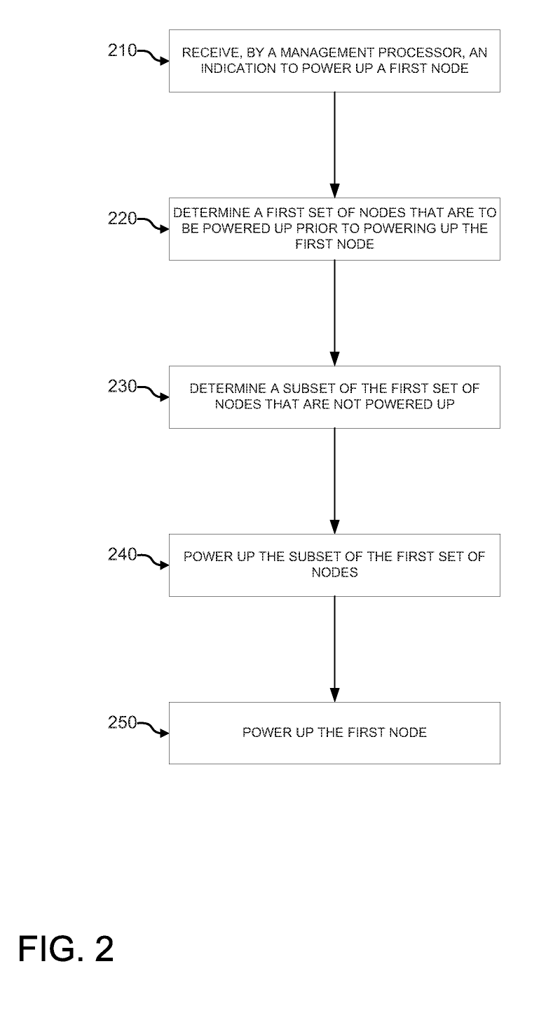

FIG. 2 is an example of a high level flow diagram for determining a power on sequence of nodes, according to techniques described herein. In block 210, a management processor may receive an indication to power up a first node. As described above, the indication may come from a power on event, such as the receipt of a magic packet over a LAN or an activation of the node's power switch. In block 220, a first set of nodes that are to be powered up prior to powering up the first node may be determined. In other words, the management processor may use the previously gathered information about node interconnection as well as the node reported information about power sequencing to determine which nodes need to be powered up before powering up the node for which the power even was received.

In block 230, a subset of the first set of nodes that are not powered up may be determined. As explained above, some nodes may be used by multiple nodes. Thus, a determination may be made as to which nodes are already powered up, and thus do not need to be powered up. In block 240, the subset of the first set of nodes may be powered up. In other words, all of the nodes that are to be powered up prior to powering up the first node and that are not already powered up, are given the signal to power up. In block 250, the first node may be powered up.

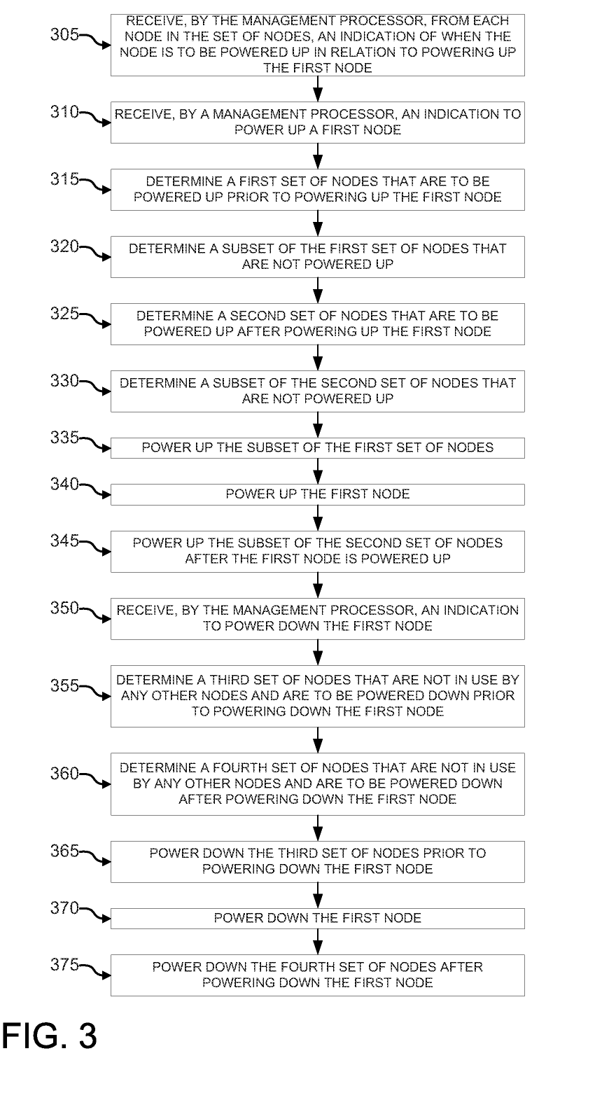

FIG. 3 is another example of a high level flow diagram for determining a power on sequence of nodes, according to techniques described herein. In block 305 a management processor may receive from each node an indication of when the node is to be powered up in relation to powering up a first node. As explained above, each node's meta-data informs the management processor of when in the power on sequence the node should be powered on. Thus, the management processor is relieved form having to receive information on the proper sequencing from an external source, because the node's meta-data itself includes the proper sequencing. In block 310, the management processor may receive an indication to power up a first node.

In block 315, a first set of nodes that are to be powered up prior to powering up the first node made be determined. In block 320, a subset of the first set of nodes that are not powered up may be determined. As explained above, in some cases a node may already be in use by other nodes and is thus already powered up. Block 320 determines nodes that are to be powered up and that are not already powered up. In block 325, a second set of nodes that are to be powered up after powering up the first node are determined. In other words, these are nodes that are to be powered up after the first node has been powered up. In block 330, a subset of the second set of nodes that are not powered up is determined. Just as above, block 330 determines nodes that are not already powered up, because nodes that are already powered up do not need to be powered up again.

In block 335, the subset of the first set of nodes may be powered up. In other words, all nodes that are to be powered up prior to the first node and that are not already powered up are sent a signal to power up. In block 340, the first node may be powered up. In block 345, the subset of the second set of nodes may be powered up after the first node is powered up. In other words, after the first node has been powered up, all nodes that are to be powered up that are not already powered up may be sent a signal to power up.

In block 350, the management processor may receive an indication to power down the first node. In block 355, a third set of nodes that are not in use by any other nodes and are to be powered down prior to powering down the first node may be determined. In block 360, a fourth set of nodes that are not in use by any other nodes and are to be powered down after powering down the first node may be determined.

In block 365, the third set of nodes may be powered down prior to powering down the first node. In block 370, the first node may be powered down. In block 375, the fourth set of nodes may be powered down after powering down the first node.

FIG, 4 is an example of a high level flow diagram for ordered powering on of nodes, according to techniques described herein. In block 410, a first node power on indication may be received. In block 420, a set of nodes associated with the first node that are not already powered on may be determined. In block 430, an order for powering on the first node and set of associated nodes that are not already powered on may be determined. In block 440, the nodes may be powered on in the determined order.

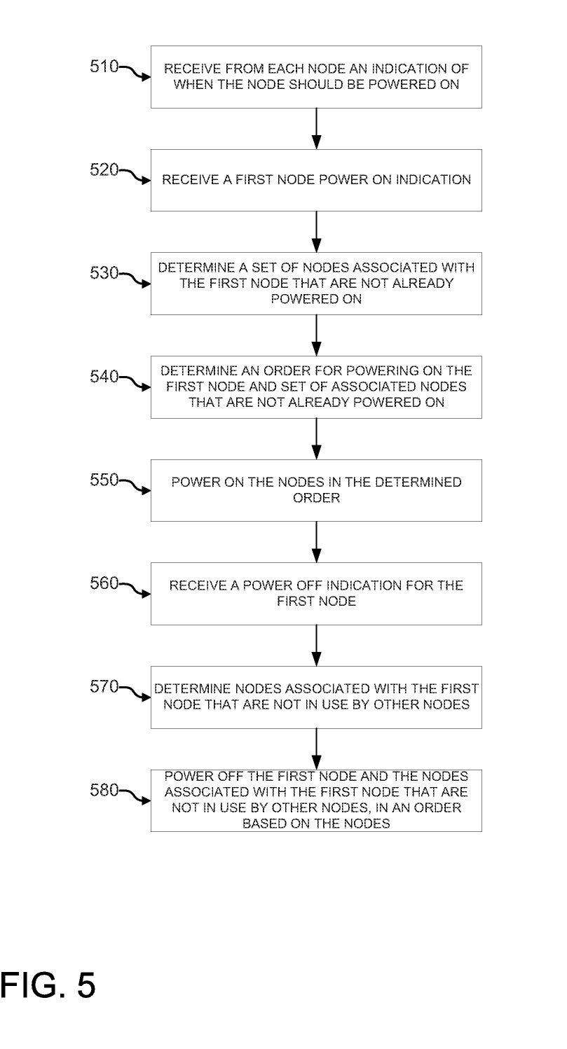

FIG. 5 is another example of a high level flow diagram for ordered powering on of nodes, according to techniques described herein. In block 510 an indication of when a node should be powered on may be received from each node. As mentioned above, each node may inform the management processor of when in the sequence of powering on nodes the node should be powered on. In block 520, an indication to power on a first node may be received. In block 530, a set of nodes associated with the first node that are not already powered on may be determined. In block 540, an order for powering on the first node and the set of associated nodes that are not already powered on may be determined.

In block 550, the nodes may be powered on in the determined order. In block 560, a power off indication for the first node may be received. In block 570, nodes associated with the first node, that are not in use by any other nodes may be determined. As explained above, a node may be used by more than one set of nodes. If one set of nodes is going to be powered off, any nodes that are in use by a different set of nodes should remain powered on. In block 580, the first node and the nodes associated with the first node that are not in use by other nodes may be powered off in an order based on the nodes. As explained above, the power off order may be determined based on information that is reported by the nodes themselves. As such, the management processor does not need any information, aside from information provided by the node itself, in order to determine the proper order for powering down nodes.

We claim:

1. A method comprising:
receiving, by a management processor, an indication o power up a first node;
determining a first set of nodes that are to be powered up prior to powering up the first node;
determining a subset of the first set of nodes that are not powered up;
powering up the subset of the first set of nodes; and
powering up the first node.

2. The method of claim 1 further comprising:
receiving, by the management processor, from each node in the set of nodes, an indication of when the node is to be powered up in relation to powering up the first node.

3. The method of claim 1 further comprising:
determining a second set of nodes that are to be powered up after powering up the first node;
determining a subset of the second set of nodes that are not powered up; and
powering up the subset of he second set of nodes after the first node is powered up.

4. The method of claim 1 wherein the indication to power up the first node is a wake on local area network (WOL) event.

5. The method of claim 1 wherein the indication to power up the first node is activation of a power button of the first node.

6. The method of claim 1 further comprising:
receiving, by the management processor, an indication to power down the first node;
determining a third set of nodes that are not in use by any other nodes and are to be powered down prior to powering down the first node;
determining a fourth set of nodes that are not in use by any other nodes and are to be powered down after powering down the first node;
powering down the third set of nodes prior to powering down the first node;
powering down the first node; and
powering down the fourth set of nodes after powering down the first node.

7. A system comprising:
a plurality of nodes, the plurality of nodes each having a type, including compute nodes, storage nodes, and input/output (IO) nodes, wherein each node is selectively powered independent of all other nodes;
a connection fabric connecting the plurality of nodes, the connection fabric providing configurable connectivity between any subset of the plurality of nodes; and
a management processor to store the subset of the plurality of nodes that are connected, the management processor further to receive a power on indication for one of nodes and to power on all of the nodes in the subset in a defined order, the order based on the node types.

8. The system of claim 7 wherein each non-compute node indicates to the management processor if it is to be powered on before or after an associated compute node is powered on.

9. The system of claim 7 wherein the management processor further determines if a node is already powered on prior to attempting to power on the node.

10. The system of claim 7 wherein the management processor is further to receive a power off indication for a node, the management processor to determine the subset of nodes connected to the node, the management processor further to determine which nodes of the subset of nodes are not in use by any other subset of nodes, the management processor further to power off the subset of nodes that are not in use by another subset of nodes in an order based on the node types.

11. The system of claim 7 wherein the power on indication is activation of a power button of the node.

12. The system of claim 7 wherein the power on indication is a wake on local area network signal.

13. A non-transitory processor readable medium containing thereon a set of instructions which when executed by a processor cause the processor to:
receive a first node power on indication;
determine a set of nodes associated with the first node that are not already powered on;
determine an order for powering on the first node and set of associated nodes that are not already powered on; and
power on the nodes in the determined order.

14. The medium of claim 13 further including instructions which cause the processor to:
receive from each node an indication of when the node should be powered on.

15. The medium of claim 13 further including instructions which cause the processor to:
receive a power off indication for the first node;
determine nodes associated with the first node that are not in use by other nodes; and
power off the first node and the nodes associated with the first node that are not in use by other nodes, in an order based on the nodes.
